(19) United States
(12) Patent Application Publication
(10) Pub. No.: US 2008/0255265 A1
(43) Pub. Date: Oct. 16, 2008

(54) Glass Filler Material and Method of Production

(76) Inventors: Stefan Hoescheler, Herrsching (DE); Dirk Albrecht, Herrsching (DE); Andrea Stippschild, Landsberg (DE); Karsten Dede, Landsberg (DE)

Correspondence Address: 3M INNOVATIVE PROPERTIES COMPANY, PO BOX 33427, ST. PAUL, MN, 55133-3427, US

(21) Appl. No.: 10/596,722

(22) PCT Filed: Dec. 22, 2004
(86) PCT No.: PCT/EP2004/014614

§ 371 Date: Jun. 22, 2006

(30) Foreign Application Priority Data
Dec. 22, 2003 (EP) 03 029 538.0

(51) Int. Cl. C08K 3/22; C03C 3/06; C03C 3/095; C03C 3/093; C03C 3/085; C03C 3/087; C03C 3/078

(52) U.S. Cl. 523/117; 501/54; 501/64; 501/67; 501/69; 501/70; 501/72

(57) ABSTRACT

The present invention relates to a glass filler material with an average particle size of 0.1-20 μm. It further relates to a method for producing a glass filler material. The glass filler material comprises 65-99.95 mol % silicon dioxide (SiO₂), 0-15 mol % aluminum and/or boron oxide (Al₂O₃, B₂O₃), 0-30 mol % zirconium and/or titanium and/or hafnium oxide (ZrO₂, TIO₂, HfO₂), Y₂O₃ and/or Sc₂O₃ and/or La₂O₃ and/or CeO₂ and/or other lanthanide oxides, 0.05-4 mol % alkali metal oxides (Na₂O, Li₂O, K₂O, Rb₂O, Cs₂O), 0-25 mol % earth alkali metal oxides (MgO, CaO, SrO, BaO). The glass filler material shows a low concentration of alkali ions and is used for composites with cationically curing properties and for dental composites and dental restoration materials.

The present invention generally relates to a glass filler material. More specifically the present invention discloses a glass filler material for composites with cationically curing properties and for dental composite materials.

The glass filler material does not influence the curing properties of the composite and does not deteriorate the mechanical properties of the cured plastic polymer (i.e. a dental filling) and does not decrease the shelf live stability of the composite.

This can be reached by a glass filler material wherein the particles of this material have an inner zone and an outer zone wherein the outer zone is almost free of alkali metal oxides and the alkali metal oxides of the inner zone do not significantly migrate to the outer zone.

The present invention further relates to a method for producing a glass filler material which does not influence the curing properties of the composite and does not deteriorate the mechanical properties of the cured plastic polymer and does not decrease the shelf live stability of the composite. More specifically it relates to a method for producing a glass filler material for composites with cationically curing properties and more specifically for dental composites.

The term “polymerizable resin” means the monomer or the mixture of monomers which undergo polymerization by adjacent initialization. The polymerizable resin may contain a certain amount of prepolymerized oligomers and/or polymers based on the monomers.

The polymerizable resin often is mixed with a filler material to enhance the properties of the uncured material. In the following this material is called “composite” or “composite material”, i.e. dental composite material.

By terms of this invention “plastic polymer” means the cured material after polymerization containing no or only small amounts of monomers. The resulting plastic polymer obtained after appropriate curing even exhibits enhanced properties by adding a filler to the polymerizable resin.

Glass filler materials for curable composites are disclosed in numerous documents.

EP 716 049 A2 discloses a barium-free dental glass with good X-ray absorption properties comprising the following (in wt. %): 50-75 silica, 5-30 zirconia, 0-5 lithium oxide, 0-25 sodium oxide, 0-25 potassium oxide and 0-25 alkali metal oxides (weight relative to oxides).

EP 634 373 discloses a barium-free dental glass with good X-ray absorption properties comprising the following (in wt. %): 45-65 silica, 5-20 boron oxide, 5-20 aluminum oxide, 0-10 calcium oxide, 15-35 strontium oxide, 0-2 fluorine.

EP 0 102 199 relates to a dental restorative composition having improved mechanical properties and hydrolytic stability. The filler disclosed in this document is an eutectic composition of SiO₂, BaO, B₂O₃ and Al₂O₃. Thus, it contains a defined, relatively high amount of BaO, B₂O₃ and Al₂O₃.

U.S. Pat. No. 6,270,562 B1 relates to a filler material for use in dental composites and dental restorations comprising a fibrous material and one or more forms of surface-modifying particles. The surface-modifying particles are bonded to the fibrous material to increase the surface area of the fibrous material and improve the bonding properties of the fibrous material to enable it to better bond to a resin matrix material in a dental composite.

WO 99/20225 describes a method of making a composition for forming a dental composite material comprising a glass fiber filler. These fibers are obtained by grinding glass fibers which have been densified and embrittled by heating glass fibers at a temperature substantially below the softening point of the glass fibers.

U.S. Pat. No. 6,022,819 relates to a porcelain composition comprising in weight percent 50-85% SiO₂, 2-18% Al₂O₃ and 2-23% of a flux. The flux is selected from the group consisting of K₂O, Na₂O, Li₂O, CaO, P₂O₅, F, BaO, B₂O₃ and mixtures thereof.

EP 997 132 A1 discloses a X-ray opaque barium-free dental glass comprising the following (in wt. %): 20-45 silicon dioxide, 5-35 aluminum oxide, 2-20 zinc oxide, 2-10 zirconium oxide, 2-10 fluorine and 1-10 sodium oxide.

DE 198 46 556 describes dental materials based on polymerizable monomers, epoxides, organic modified polysiloxanes, liquid crystal monomers, oxethanes, spiro-ortho esters or carbonates as binders, a catalyst for hot, cold or photo-polymerization, 20-70 wt. % inorganic filler (A), 0-60 wt. % other fillers (B) and 0-2 wt. % conventional additives. The inorganic filler (A) consists of a porous glass ceramic having micro- and/or meso-pores filled with the binders optionally in polymerized form.

WO02/055028 A2 describes a polymerizable dental material with a filler material. The filler material is produced by means of a melting method and is selected so that it has a refractive index of n_{D}=1.49 to 1.54 so that the viscosity of the polymerizable dental material, after a period of at least 9 month during which it was stored at a temperature ranging form 20 to 25° C., has a value of +/−50% of the initial value measured 24 hours after the polymerizable dental material was produced, and so that the polymerizable dental material has a reactivity of the type that, once polymerization is initiated, the amount of the maximum heat flux generated by the dental material equals at least 0.8 mW/mg, and this maximum heat flux is attained within a period of no longer than 60 seconds.

EP 023 013 B1 relates to a calcium aluminium fluorosilicate glass powder having an average particle size of at least 0.5 μm wherein the powder particles are so depleted of calcium at their surface that the quotient of the atomic ratio Si/Ca at the surface of the powder particles and the atomic ratio Si/Ca in the core region is at least 2.0. It further describes a method to remove these ions from the particle surface up to a depth of about 50 nm. This calcium aluminium fluorosilicate glass powder is used for a glass ionomer cement.

A method for preparing glass substrates is disclosed in EP 819 103. In one step the surface of a silica-soda-lime glass substrate is treated to a first depth with an ion-exchange treatment for a sufficient first time and first temperature to provide an ion-exchanged treated glass having a strengthened surface. In a following step the surface of the ion-exchanged treated glass is treated to a second depth with a dealkalization treatment for a sufficient second time and second temperature to remove alkaline ions from the glass surface, wherein the second depth is less than the first depth. In this disclosure the method of dealkalization is only useful to remove the ions to a depth of less than 1 μm. It further needs temperatures of more than 100° C. The dealkalization is carried out with AlCl₃ or (NH₄)₂SO₄. Fillers treated with these reagents are not usable for the composites described herein as they result in other problems of the filled composites like short storage time. The dealkalization is described only for hard surfaces like disks and not for powder particles.

A further method of making dealkalized glass is disclosed in DE 37 41 031 A1. The glass is brought into contact with the acidic gas of a dealkalizing medium. It is especially useful for products with coated glass parts as mirrors.

Glass filler materials are used to increase the mechanical properties of plastic polymers. Through the addition of glass filler materials to polymerizable resins the resulting composite materials exhibit good handling characteristics as they are formable and do not stick to the handling tools. The cured plastic polymers of these filled composite materials further show improved strength, elastic modulus, hardness and wear resistance for the cured plastic polymer. Such composites are used in electronical engineering, precision work technique, for constructing of though housings, in household and in medical applications, for example as joint implants or as dental materials.

For dental composite materials the fillers have to meet further requirements as X-ray opacity, dielectrical properties, biocompatibility and a certain refractive index. In order to obtain dental materials with a desirable translucency in visible light this refractive index should be closed to the refractive index of the polymerizable resin.

The polymerizable resin composition further demands certain chemical properties of the filler. This means that the filler should not influence the polymerization reaction and should not interact with the initiator system. The polymerization is started in different ways for example by mixing a base part of the resin with an initiator containing part of the resin (two component system) or by exposing light to the resin containing a light sensitive initiator system. The initiator systems used in the state of the art react on a radical basis or on an ionic, preferred a cationic basis. Thus, they are sensitive to the presence of water, basic substances or acids.

Mainly used filler materials are quartz or glass. Because of the defined chemical composition the quartz material has a refractive index of n_{D}=1.55. For a lot of polymerizable resins with different refractive indices a filler with this index is only minor suitable as a translucent composite is not available. For a glass filler, the reasonable refractive index of the filler is adjustable by the adjacent composition of the glass.

To obtain a glass filler material, the main components as SiO₂, B₂O₃, P₂O₅ are mixed together with other oxides, hydroxides or carbonates of elements of group I and II, of transition elements or of lanthanides. The mixture is melted to the glass at temperatures of 1250 to 1650° C. Of importance are the components with elements of the main group I (Li, Na, K, Rb, Cs) which significantly decrease the melting temperature as well as the viscosity of the melted glass. Thus, for the glass filler materials known from the state of the art, the amount of these elements normally ranges between 5 and 40 mol %.

It is further known that different acidic ingredients as B₂O₃ or P₂O₅ also decrease the melting temperature of the glass mixture.

The presence of acidic, amphoteric or basic oxides is a disadvantage for the fillers as these glass filler materials do not have the demanded chemical properties. When used as a filler of polymerizable resins the acidic, amphoteric or basic oxides do interact with the monomers or with the initiators systems. The use of glass filler materials with the elements of the main group I in the said concentrations in composites results in low mechanical properties of the cured plastic polymer. An amount of acidic or amphoteric oxides as disclosed in the state of the art leads to a shortened storage time of the composites. The storage time is especially decreased for composites with cationically curing monomers.

If a glass material is desired without these elements of main group I or the acidic ingredients the melting process has to be carried out at very high temperatures. This high temperature melting method is time consuming and very expensive. The obtained glass materials have the tendency to crystallize what is not acceptable for fillers used in dental materials.

It is thus an object of the present invention to avoid one or more of the problems mentioned above.

A further object is to provide a new glass filler material for composite materials and to provide a glass filler material with improved properties. Another further object is to provide a glass filler material with a concentration of alkali metal oxides which allows to melt the glass filler material at suitable temperatures and which allows at the same time a composite material with good polymerization properties and good mechanical properties of the cured plastic polymer.

A further object is to provide a method of producing such a glass filler material. Still a further object is to provide a dental composition containing these glass filler materials.

One or more objects can be achieved by providing a glass filler material as described in the text below.

According to the present invention the glass filler material comprises
a) 65-99.95 mol % silicon dioxide (SiO₂),
b) 0-15 mol % aluminum and/or boron oxide (Al₂O₃, B₂O₃),
c) 0-30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanidoxides
d) 0.05-4 mol % alkali metal oxides (Na₂O, Li₂O, K₂O, Rb₂O, Cs₂O)
e) 0-25 mol % earth alkali metal oxides (MgO, CaO, SrO, BaO).

Preferably, the glass filler material comprises:
a) 75-96.95 mol % silicon dioxide (SiO₂),
b) 0-10 mol % aluminum and/or boron oxide (Al₂O₃, B₂O₃),
c) 3-30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanide oxides,
d) 0.05-3 mol % alkali metal oxides (Na₂O, Li₂O, K₂O, Rb₂O, Cs₂O),
e) 0-15 mol % earth alkali metal oxides (MgO, CaO, SrO, BaO).

In another preferred embodiment, the glass filler material comprises
a) 75-96.95 mol % silicon dioxide (SiO₂),
b) 0-5 mol % aluminum and/or boron oxide (Al₂O₃, B₂O₃),
c) 3-30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanide oxides,
d) 0.05-2 mol % alkali metal oxides (Na₂O, Li₂O, K₂O, Rb₂O, Cs₂O),
e) 0-5 mol % earth alkali metal oxides (MgO, CaO, SrO, BaO).

The particles of the inventive glass filler material have an inner zone and an outer zone up to 1.5 μm and wherein the mean concentration of alkali ions of the outer zone relative to the mean concentration of alkali ions of the inner zone is 10% or less and the alkali ions of the inner zone do not significantly migrate to the outer zone.

The concentration of the alkali ions in the inner or outer zone of the particles of the inventive glass filler material mostly follows a gradient. Normally, the concentration of alkali ions increases from the surface of the particle to its center. Thus, the mean concentration of alkali ions as it is described herein means the average concentration of alkali ions that is present in the whole inner or outer zone without respect to the gradient.

As the migration of alkali ions is avoided by the glass filler material of the invention it is reached that a glass filler material with acidic, amphoteric or basic oxides can be used in an equal manner as a glass filler material without these oxides.

Especially for dental composites and in particular for cationically curable dental composites a filler without release of these oxides is useful as it results in high self live stability. The glass filler materials of the present invention do not influence the polymerization reaction of a polymerizable resin and do not interact with the initiator systems of such dental composites.

The glass filler particles have an average particle size of 0.1-20 μm and preferable the average particle size is from 0.5 to 3 μm and more preferable from 0.5 to 1 μm. Within these preferred particles sizes the particles of the invention have an inner zone and an outer zone where the outer zone is up to 1.5 μm. In some cases the thickness of the outer zone could even be about 2 μm or more.

It is the intention of this invention to differentiate the inner zone of the particles from the outer zone by the profile of alkali ion concentration or even alkali oxide concentration versus the layer depth of the particle.

This profile is attachable by an analysis of the alkali concentration of the surface of the particles by a suitable method. The method used for this invention is the photoelectron spectroscopy (ESCA). This method of analysis describe R. S. Swingle II and W. M. Riggs in “Critical review in Analytical Chemistry” (Volume 5, Issue 3, pages 267-321, 1975) as well as K. Levsen in “Chemie unserer Zeit” (10^{th} annual, 1976, no. 2, pages 48-53).

The particle profile shows the concentration [mol %] of Na+ or other alkali ions on the y-axis versus the layer depth of the particle in [nm] on the x-axis starting at 0 nm indicating the surface of the particle. Normally the profile is detected to a depth corresponding to the radius of the particle or less than this radius. It usually has a significant increase of the alkali ion concentration when passing from the outer zone to the inner zone of the particle. The layer depth in the maximum of the first derivation of the concentration to the layer depth (f′=d(conc)/d(depth)) represents the thickness of the outer zone. The maximum is characterized in that the second derivation becomes 0 (f″=0) at the same value of depth.

A common profile of a particle with an outer zone of about 850 nm and a diameter of 4 μm or more is shown in the FIG. 1:

The depth of the outer zone of the particles is preferably about 1.5 μm even for very large particles. It could be larger depending on which alkali ion is present in the glass filler material.

For these particles with diameters smaller than 3 μm nearly the whole particles consist of the outer zone and possibly no inner zone is detectable by the ESCA method.

For the particles according to the invention the mean concentration of alkali ions of the outer zone relative to the mean concentration of alkali ions of the inner zone is 10% or less and the alkali ions of the inner zone do not significantly migrate to the outer zone. It doesn't make any difference for the invention if the concentration of alkali metal oxides of the particles is counted in oxides or in cations. Despite it is very clear that for the migration process in filler materials only the cations are of interest as only the ionic parts of the oxides are subjected to any detectable migration.

The limitation that the alkali ions do not migrate “significantly” is based on the fact that it is not possible to totally exclude any motions of the ions especially if these motions are very limited and small. But it is an important feature of the invention that almost no migration takes place. This means for example that only 0.5% of the alkali ions of the inner zone migrate after a time of storing the filler material for nine month at a temperature of 25° C. It is most preferred that only 0.1% of the alkali ions migrate to the outer zone under these storage conditions.

Especially, it is part of the present invention that the alkali ions are fixed in the particles by a drying process. A drying process is described more detailed below.

To provide glass filler materials which result in composites with good mechanical properties and an adequate storing it is preferred that the filler material has an amount of alkali metal oxides from 0.05 to 2 mol %. Most preferably the concentration of alkali metal oxides in the filler material is not over 1 mol %. The claimed amount of alkali metal oxides is the total amount of the particle without respect to the different concentrations of the inner and the outer zone of the particles.

The maximal particle size of the glass filler material is 100 μm. More preferred is a maximal particle size of 5 μm. In case the glass filler material is used as a filler of a dental cement the maximal particle size is 25 μm, preferably 20 μm. To reach excellent mechanical properties of the cured plastic polymer the statistic distribution of the particle size is not to narrow. This appropriate distribution is available by the known milling processes and the separation of the coarse grained fraction.

The filler material of the invention has a refractive index (n_{D}) of 1.49 to 1.55. The refractive index is elected in that way that it is closed to the refractive index of the polymerizable resin.

The glass filler material of the invention is used in the dental restorative field in composite formulations, especially for fillings, bondings, dental cements, pit and fissure sealeants, cavity lining, core build up.

Further the fillers could be use for materials for temporary crowns and bridges, for root fillings, for sub fillings, for dental protheses materials such as inlays, onlays, crowns, bridges and for a denture material.

Most favorable is their uses in polymerizable materials and especially in composites with cationically curing properties.

They may be even useful for other dental materials as glass ionomer cements, compomers, blending material for crowns or bridges, ceramics.

The described glass filler material is available by the following method.
a) melting a composition of 54-91 mol % SiO₂, 0-13.6 mol % Al₂O₃ and/or B₂O₃, 0-27.3 mol % ZrO₂ and/or TiO₂ and/or HfO₂ and/or Y₂O₃ and/or Sc₂O₃ and/or La₂O₃ and/or Ce₂O₃ and/or other lanthanide oxides, 9-20 mol % alkali metal oxides, 0-22.7 mol % earth alkali oxides at a temperature of 1200-1800° C. for at least 30 minutes,
b) crushing the melted glass by transferring into cold water or on metal rollers,
c) milling the glass granulate obtained by b) to a mean particle size of d₅₀ from 0.1 to 20 μm,
d) dealkalizing the glass powder in excess with a dealkalizing agent,
e) removing the dealkalizing agent and washing the glass powder with a polar solvent until the filtrate reacts neutral,
f) drying the glass powder at a temperature of 200 to 1100° C. for at least 30 minutes.
   The best melting temperature depends on the amount of the different ingredients. Especially Al₂O₃, B₂O₃ and alkali metal oxides help to decrease the melting temperature of the mixture. Preferable the melting temperature is from 1400 to 1700° C. and more preferably from 1450 to 1550° C.

The melted glass is crushed. This could be done by transferring it into could water or on metal rollers. At the same time, the glass melt is cooled. The whole melting and crushing procedure could be carried out in a discontinuous or a continuous process. A possible melting crucible is a platinum crucible.

After crushing the melt the obtained glass granulate is milled to a mean particle size of d₅₀ from 0.1 to 20 μm. For the pre-milling of the crushed glass to a particle size of about 300 μm an agate disc mill could be used. Preferred milling methods for fine milling particles with an average size of 300 μm and smaller into the range of d₅₀<20 μm are ball mills. In these mills the preferred balls are yttrium-stabilized ZrO₂-balls with a diameter of 0.8 mm. The milling container of these ball mills could be coated with Al₂O₃.

The dealkalizing agent should be an acidic composition able to solve alkaline ions. Examples for a dealkalizing agent are inorganic or organic acids as HCl, HJ, HBr, H₂SO₄, H₃PO₄, HNO₃, HClO₄, CH₃COOH, COOH—COOH, H—COOH, citric acid, tartaric acid or polycarboxylic acid. These acids are used in concentrations of 10 to 30% acid in water. Preferred examples are 10% CH₃COOH, 10% HCOOH, 30% HCl or 15% HNO₃. Mixtures of the described acids could be used as well. The dealkalizing step is performed at a temperature of 50 to 200° C. Most preferred is a temperature of 100 to 120° C. The dealkalizing agent is used in excess. This surplus ratio of dealkalizing agent to the glass powder to be dealkalized is important for the invention. Especially it is a ratio of at least 1:5 to 1:1000.

It is a feature of this invention that the ratio of the glass powder to the dealkalizing agent is 1:1 to 1:1000. Preferably the ratio is 1:10 and more preferably 1:20.

Surprisingly with this dealkalizing step a glass filler material is obtained with an outer zone of up to 1.5 μm wherein this outer zone is almost free of alkali ions. The washing methods known from the art only lead to a depletion of certain ions as Ca⁺⁺ (U.S. Pat. No. 4,376,835) or Ba⁺⁺ or Sr⁺⁺ (EP 0 102 199) in a very small layer on the surface of the particles. The depleted surface is limited to a thickness of the layer of about 50 nm. Thus, the process of the present invention shows an advantage as a very broad outer zone of up to 1.5 μm is almost free of alkali ions.

It is further not expected that the alkali of the inner zone do not significantly migrate to the outer zone. The principles of the balance between different concentrations will assume that a migration occurs from the zone with the higher concentration to the zone with the lower concentration. Despite this, no significant migration between the two zones occurs.

The polar solvent for washing the dealkalized glass powder consists of water or a mixture of water with other polar solvents, preferably ethanol or acetone. The washing step could take place at different temperatures depending on the polar solvent. It is preferably performed at room temperature.

The drying of the glass powder could be done at a temperature of 200 to 1100° C. for at least 0.5 hours. It must be a temperature clearly below the sintering temperature of the glass composition in order to avoid the sintering of the particles. This temperature varies for the different compositions of glasses. A temperature of 500 to 1000° C. is useful of most of the glass compositions and a temperature of 800 to 1000° C. is preferred.

After drying a sieving process could be added to remove the coarse fraction of the particles. For example a 200 μm meshed screen. This sieving step is not mandatory.

The particles obtained by the described method have an average particle size d₅₀ from 0.1 to 20 μm. Preferably they have an average particle size d₅₀ from 0.5 to 3 μm and more preferably from 0.5 to 1 μm.

Of these glass filler materials a polymerizable dental material is available containing:
a) 3-80 wt. % of one or more cationically and/or radically curable monomers,
b) 3-90 wt. % of the glass filler material of the invention,
c) 0-90 wt. % of one or more radio-opaque fillers,
d) 0.01-25 wt. % of initiators, retarders and/or accelerators,
e) 0-25 wt. % of auxiliary agents

The curable monomers are selected for example from the group of ethylenically unsaturated monomers, for example from methacrylate or acrylate resins, and preferred from epoxy, oxetane, vinyl ether and spiro-orthocarbonate resins, and combinations thereof. Preferably, the cationically polymerizable monomers comprise an epoxy resin, especially a silicon-containing epoxy resin, or a blend of a silicon-containing epoxy resin and an epoxy resin that does not contain silicon. Suitable fillers for radiopaque formulations are described in EP-A2-0 189 540, EP-B-0 238 025, and U.S. Pat. No. 6,306,926 B1.

As initiators are possible for example systems comprising an iodonium salt and a visible light sensitizer, and optionally an accelerator. The iodonium salt may be a diaryl iodonium salt such as diaryliodonium hexafluorophosphate, diaryliodonium hexafluoroantimonate, 4-octyloxyphenyl phenyliodonium hexafluoroantimonate, 4-(2-hydroxytetradylecoxyphenyl)phenyliodonium hexafluoroantimonate, 4-(1-methylethyl)phenyl 4-methylphenyliodonium tetrakis(pentafluorophenyl)borate, and combinations thereof.

The visible light sensitizer may be selected from ketones, coumarin dyes, xanthene dyes, fluorone dyes, fluorescein dyesaminoketone dyes, p-substituted aminostyryl ketone compounds, and combinations thereof. More preferably, the visible light sensitizer is an alpha-diketone; camphorquinone is particularly preferred.

The accelerators may be selected from the group of polycyclic aromatic compounds.

The polymerizable dental materials which could contain the glass filler material of the invention are for example described in WO 98/47046, WO 01/51540 A2, WO 98/22521 and WO 02/055028 A2 which are incorporated to this disclosure by reference. Most preferred are the polymerizable materials containing cationically curable monomers as composite

The glass filler material of the invention as obtained by the described method is used as mentioned above in the dental field. In the dental restorative field it is used in favor for composite formulations, especially for fillings, bondings, dental cements, pit and fissure sealeants, cavity lining, core build up. Most favorable is their uses in polymerizable materials and especially in composites with cationically curing properties.

### EXAMPLES

For all examples conventional raw materials for glass melting as oxides, carbonates or hydroxides of the corresponding elements are used. Shown in the following table 1 are the compositions of the melted glass mixtures calculated as oxides of these elements as they result after melting. (all oxides in mol %, up to an amount of 150.0 g for each example):

TABLE 1

| | Example no.: | | | | | | | | | |
|---|---|---|---|---|---|---|---|---|---|---|
| | 1 | 2 | 3 | 4 | 5 | 6 | 7 | 8 | 9 | 10 |
| SiO₂ | 70 | 75 | 70 | 74 | 80 | 75 | 85 | 85 | 73 | 73 |
| Li₂O | | | 20 | | | 14 | | | 5 | 14 |
| Na₂O | 16 | 11 | | 16 | 12 | | 12 | 15 | 8 | |
| K₂O | | | | | 4 | | | | | |
| Al₂O₃ | 2 | | | | | | | | | 1 |
| B₂O₃ | | 4 | | | | | | | | |
| MgO | 2 | | | | | | | | 2 | |
| SrO | | | | | | | | | 2 | |
| La₂O₃ | | | | | | | | | 10 | |
| Y₂O₃ | | 10 | | | | 11 | | | | 6 |
| ZrO₂ | 10 | | 5 | 10 | 4 | | 3 | | | 6 |
| TiO₂ | | | 5 | | | | | | | |

For each example 1 to 10 the raw materials like oxides, carbonates and/or hydroxides in an amount and a ratio to give 150 g of the above mentioned molar compositions in the resulting glass melt are mixed together. The mixture for each example is melted in a 400 ml Platinum crucible (PT10Rh) at a temperature of 1500 to 1640° C. For this application in a laboratory dimension a discontinuous process is used. For a larger amount of materials a continuous process is more useful. After a melting time of 1 to 2 hours the melted glass is quenched by bringing it into a stainless steel vessel with 10 l distilled water.

The glass material of each example is milled in a first step in an agate disc mill to a powder with a particle size of d₅₀<300 μm. In a second step the premilled powder is fine milled in a ball mill. Therefore, 150 g of the premilled powder, 200 ml isopropylic alcohol and 1100 g of yttrium-stabilized balls made of ZrO₂ are brought into a vessel of a volume of 1 liter. The balls have a diameter of 0.8 mm. The vessel is coated with Al₂O₃. The milling step is performed until the powders have an average particle size d₅₀ of 0.6 to 1 μm.

After milling, the powders of example 1 to 3 are treated with 15% HNO₃, the powder of example 4 is treated with 10% CH₃COOH, the powders of example 5 to 8 are treated with 10% CHOOH und the powders of example 9 and 10 are treated with 30% HCl. All examples are dealkalized with the mentioned acids at a temperature of 100 to 120° C. under heating and stirring in a reflux condenser for 16 hours. The ratio of powder to fluid for all examples is 1:15.

After dealkalizing each powder the dealkalizing agent is removed. The acid-powder-mixture is filtered in a pressure filter funnel with a fritted disc containing a 0.4 μm PTFE(Teflon®) membrane. For washing the amount of 150 g of each powder an amount of 10 l distilled water is used.

Than each powder is brought into a Al₂O₃ crucible and dried at a temperature of 600° C. in a circulation oven, except the powder of example 4 which is dried at 920° C.

The dried powders are sieved through a 200 μm meshed screen.

The following table 2 shows the composition of the glass filler materials in mol % of example 1 to 10 after the described process. The analysis is performed by ICP (Fraunhofer Gesellschaft Germany):

TABLE 2

| | example no.: | | | | | | | | | |
|---|---|---|---|---|---|---|---|---|---|---|
| | 1 | 2 | 3 | 4 | 5 | 6 | 7 | 8 | 9 | 10 |
| SiO₂ | 85.0 | 86.1 | 86.2 | 85.9 | 94.4 | 86.2 | 96.1 | 99.2 | 88.1 | 84.9 |
| Li₂O | | | 1.2 | | | 1.1 | | | 0.3 | 1.0 |
| Na₂O | 0.8 | 0.7 | | 1.5 | 0.6 | | 0.5 | 0.8 | 0.4 | |
| K₂O | | | | | 0.2 | | | | | |
| Al₂O₃ | 1.2 | | | | | | | | | 1.0 |
| B₂O₃ | | 2.0 | | | | | | | | |
| MgO | 1.2 | | | | | | | | 1.0 | |
| SrO | | | | | | | | | 1.2 | |
| La₂O₃ | | | | | | | | | 9.0 | |
| Y₂O₃ | | 11.2 | | | | 12.7 | | | | 6.1 |
| ZrO₂ | 11.8 | | 6.2 | 12.4 | 4.8 | | 3.4 | | | 7.0 |
| TiO₂ | | | 6.4 | | | | | | | |

In table 3 the physical properties of the glass filler materials are listed. The refractive index is defined by the immersion method (Infracor Hanau). The pH value of the glass filler materials is measured before and after the dealkalizing step to show the magnitude of migration of the basic oxides out of the outer zone. Therefore, 1 g of the powder is dispersed in 100 ml distilled water with a magnet stirrer. The pH-value is taken with an H⁺-electrode after a constant value appeared. To measure the X-ray opacity a composite material containing the glass filler material is prepared. Therefore,

| | | |
|---|---|---|
| 30 | g | 1,3,5,7-Tetrakis(2,1-ethanediyl-3,4-epoxycyclohexyl)-1,3,5,7- |
| | | tetramethyl-cyclotetrasiloxane, |
| 1.8 | g | Tolylcumyliodonium-tetrakis(pentafluorophenyl)borate, |
| 0.2 | g | 2-Butoxyethyl-4-(dimethylamino)benzoate, |
| 0.5 | g | Camphorquinone |

are mixed together under light exclusion. Than, 72 g of the glass filler material according to example 1 to 10 are kneaded into the monomer composition. The resulting composite is brought into round test platelets (diameter 1.5 cm and thickness 1.5 mm) of the material cured by light exposure with Elipar Freelight® for 40 s. The resulting cured plastic polymer platelets are measured according to ISO 4049.

TABLE 3

| | example no.: | | | | | | | | | |
|---|---|---|---|---|---|---|---|---|---|---|
| | 1 | 2 | 3 | 4 | 5 | 6 | 7 | 8 | 9 | 10 |
| refractive | 1.53 | 1.52 | 1.53 | 1.54 | 1.50 | 1.52 | 1.49 | 1.47 | 1.52 | 1.52 |
| index n_{D} | | | | | | | | | | |
| pH | 11 | 11.5 | 12 | 10.5 | 11 | 11 | 11.5 | 11 | 11 | 11.5 |
| before | | | | | | | | | | |
| dealkalizing | | | | | | | | | | |
| pH | 8 | 8.5 | 8.5 | 7.5 | 7.5 | 7 | 7.5 | 7.0 | 7.5 | 8 |
| after | | | | | | | | | | |
| dealkalizing | | | | | | | | | | |
| X-ray | 200 | 200 | 150 | 120 | 190 | 100 | 80 | 190 | 200 | 140 |
| opacity | | | | | | | | | | |

All glass filler materials of examples 1 to 10 show a refractive index between 1.47 and 1.54 which is in the range to get a translucent cured plastic polymer with most of the common polymerizable resins. All glass fillers exhibit a sufficient X-ray opacity after incorporating them into a composite material.

The mean molar concentration of alkali ions (Li⁺, Na⁺ and K⁺) in the outer zone of the particles (surface layers up to a depth of about 2 μm) before and after storage (9 month, 25° C.) was investigated by ESCA. The same investigation was performed for the inner zone of the particles (deeper layers in a depth of 3 μm and more).

With ESCA, a concentration profile showing the alkali ion concentration in a certain depth of the particle (in nm) was monitored. Out of this profile the boundary between inner and outer zone were easily defined. For each zone the average molar concentration of alkali ions was calculated by integration over the profile.

The mean concentrations of alkali ions (Na⁺+Li⁺+K⁺) [mol %] in the different zones are summarized in the following table 4.

TABLE 4

| | example no.: | | | | | | | | | |
|---|---|---|---|---|---|---|---|---|---|---|
| | 1 | 2 | 3 | 4 | 5 | 6 | 7 | 8 | 9 | 10 |
| mean molar conc. | 0.0 | 0.0 | 0.05 | 0.1 | 0.0 | 0.0 | 0.0 | 0.0 | 0.0 | 0.05 |
| of alkali ions in the | | | | | | | | | | |
| outer zone | | | | | | | | | | |
| (before storage) | | | | | | | | | | |
| mean molar conc. | 0.8 | 0.7 | 1.15 | 1.4 | 0.8 | 1.1 | 0.5 | 0.8 | 0.7 | 0.95 |
| of alkali ions in the | | | | | | | | | | |
| inner zone | | | | | | | | | | |
| (before storage) | | | | | | | | | | |
| mean molar conc. | 0.0 | 0.0 | 0.06 | 0.1 | 0.0 | 0.0 | 0.0 | 0.0 | 0.0 | 0.06 |
| of alkali ions in the | | | | | | | | | | |
| outer zone | | | | | | | | | | |
| (after storage) | | | | | | | | | | |
| mean molar conc. | 0.8 | 0.7 | 1.14 | 1.4 | 0.8 | 1.1 | 0.5 | 0.8 | 0.7 | 0.94 |
| of alkali ions in the | | | | | | | | | | |
| inner zone | | | | | | | | | | |
| (after storage) | | | | | | | | | | |

The data surprisingly show that no detectable migration of alkali ions occurs after storage. They further show that for the particles according to the invention the mean concentration of alkali ions of the of outer zone relative to the mean concentration of alkali ions of the inner zone is 10% or less. It was not expected in view of the state of the art that by this method of producing glass filler materials the particles outer zone could have a depth of up to 1.5 μm.

The composite materials made with the fillers according to the invention have good handling characteristics and the cured plastic polymers made from these composites exhibit very good mechanical properties as strength, hardness, elastic modulus and wear resistance. Additionally, they have an increased shelf live and polymerize entirely.

1-18. (canceled)

19. A glass filler material for use in dental composites and dental restorations, the material comprising:
a) about 65 to about 99.95 mol % silicon dioxide (SiO₂),
b) 0 to about 15 mol % aluminum and/or boron oxide (Al₂O₃, B₂O₃),
c) 0 to about 30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanide oxides,
d) about 0.05 to about 4 mol % alkali metal oxides (Na₂O, Li₂O, K₂O, Rb₂O, Cs₂O), and
e) 0 to about 25 mol % earth alkali metal oxides (MgO, GaO, SrO, and BaO),
wherein the glass filler particles have an average particle size of about 0.1 to about 20 μm and wherein these particles have an inner zone and an outer zone up to 1.5 μm and wherein the mean concentration of alkali ions of the outer zone relative to the mean concentration of alkali ions of the inner zone is 10% or less and the alkali ions of the inner zone do not significantly migrate to the outer zone.

20. A glass filler material for use in dental composites and dental restorations, the material comprising:
a) about 75 to about 96.95 mol % silicon dioxide (SiO₂),
b) 0 to about 10 mol % aluminum and/or boron oxide (Al₂O₃, B2O₃),
c) about 3 to about 30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanide oxides,
d) about 0.05 to about 3 mol % alkali metal oxides (Na₂O, Li₂O, K₂O, Rb₂O, Cs₂O), and
e) 0 to about 15 mol % earth alkali metal oxides (MgO, CaO, SrO, BaO), wherein these particles have an inner zone and an outer zone up to 1.5 μm and wherein the mean concentration of alkali ions of the outer zone relative to the mean concentration of alkali ions of the inner zone is 10% or less and the alkali ions of the inner zone are fixed in the particles by a drying process.

21. The glass filler material according to claim 19 or 20 comprising:
a) about 75 to about 96.95 mol % silicon dioxide (SiO₂),
b) 0 to about 5 mol % aluminum and/or boron oxide (Al₂O₃, B₂O₃),
c) about 3 to about 30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanide oxides,
d) about 0.05 to about 2 mol % alkali metal oxides (Na₂O, Li₂O, K₂O, Rb₂O, Cs₂O), and
e) 0 to about 5 mol % earth alkali metal oxides (MgO, CaO, SrO, BaO).

22. The glass filler material according to claim 19, wherein the concentration of e) alkali metal oxides is not over 2 mol.

23. The glass material according to claim 19, wherein the glass filler particles have an average particle size of about 0.5 to about 3 μm.

24. The glass material according to claim 19, wherein the maximal particle size is up to 100 μm.

25. The glass material according to claim 19, wherein the refractive index n_{D} of the glass filler material is in the range of about 1.49 to about 1.55.

26. The glass filler material according to claim 20, wherein the concentration of e) alkali metal oxides is not over 2 mol %.

27. The glass material according claim 20, wherein the glass filler particles have an average particle size of about 0.5 to about 3 μm.

28. The glass material according to claim 20, wherein the maximal particle size is up to 100 μm.

29. The glass material according to claim 20, wherein the refractive index n_{D} of the glass filler material is in the range of about 1.49 to about 1.55.

30. A method for producing a glass filler material for use in dental composites and dental restorations with an average particle size of 0.1 to 20 μm by
a) melting a composition of about 54 to about 91 mol % SiO₂, 0 to about 13.6 mol % Al₂O₃ and/or B₂O₃, O to about 27.3 mol % ZrO₂ and/or TiO₂ and/or HfO₂ and/or Y₂O₃ and/or Sc₂O₃ and/or La₂O₃ and/or Ce₂O₃ and/or other lanthanide oxides, about 9 to about 20 mol % alkali metal oxides, 0 to about 22.7 mol % earth alkali oxides at a temperature of about 1200 to about 1800° C. for at least 30 minutes,
b) crushing the melted glass by transferring into cold water or on metal rollers,
c) milling the glass granulate obtained by b) to a mean particle size of d₅₀ from about 0.1 to about 20 μm,
d) dealkalizing the glass powder in excess with a dealkalizing agent,
e) removing the dealkalizing agent and washing the glass powder with a polar solvent until the filtrate reacts neutral, and
f) drying the glass powder at a temperature of about 200 to about 1100° C. for at least 30 minutes.

31. The method according to claim 30, wherein the melting temperature is from about 1400 to about 1700° C.

32. The method according to claim 30, wherein the dealkalizing agent is an acidic composition.

33. The method according to claim 30, wherein the dealkalizing agent is an inorganically or organically acid selected from the group consisting of HCl, HJ, HBr, H₂SO₄, H₃PO₄, HNO₃, HClO₄, CH₃COOH, COOH—COOH, H—COOH, citric acid, tartaric acid and polycarboxylic acid.

34. The method according to claim 30, wherein the polar solvent consists of water or a mixture of water with other polar solvents, preferably ethanol or acetone.

35. The method according to claim 30, wherein is dealkalizing is performed at temperatures of about 50 to about 200° C.

36. The method according to claim 30, wherein the ratio of the glass powder to the dealkalizing agent is about 1:5 to about 1:1000.

37. A glass filler material for use in dental composites and dental restorations, the material comprising:
a) about 75 to about 96.95 mol % silicon dioxide (SiO₂),
b) 0 to about 10 mmol % aluminum and/or boron oxide (Al₂O₃, B₂O₃),
c) about 3 to about 30 mol % zirconium and/or titanium and/or hafnium oxide (ZrO₂, TiO₂, HfO₂), Y₂O₃ and/or Sc₂O₃ and/or La₂O₃ and/or CeO₂ and/or other lanthanide oxides,
d) about 0.05 to about 3 mol % alkali metal oxides (Na₂O, Li₂O, K₂O, Rb₂O, CS₂O),
e) 0 to about 15 mol % earth alkali metal oxides (MgO, CaO, SrO, BaO),
wherein the particles of the glass filler material are produced by the method of claim 30.

38. A polymerizable dental material containing:
a) about 3 to about 80 wt. % of one or more cationically and/or radically curable monomers,
b) about 3 to about 90 wt. % of the glass filler material of claim 19 or 20,
c) 0 to about 90 wt. % of one or more radio-opaque fillers,
d) about 0.01 to about 25 wt. % of initiators, retarders and/or accelerators, and
e) 0 to about 25 wt. % of auxiliary agents.

39. A polymerizable dental material according to claim 38, wherein the curable monomer is an epoxide monomer.
